(19) United States
(12) Patent Application Publication
(10) Pub. No.: US 2009/0234660 A1
(43) Pub. Date: Sep. 17, 2009

(54) SYSTEM AND METHOD FOR FUNDING EXERCISE OF PREEMPTIVE RIGHTS

(75) Inventors: Louis P. Berneman, Philadelphia, PA (US); Robert Adelson, Merion Station, PA (US)

Correspondence Address: rudoler & derosa llc;ATTN: DOCKET CLERK, 2 BALA PLAZA,, SUITE 300, BALA CYNWYD, PA, 19004, US

(73) Assignee: Osage University Partners GP I, LLC, Bala Cynwyd (PA)

(21) Appl. No.: 12/047,005

(22) Filed: Mar. 12, 2008

(51) Int. Cl. G06Q 90/00

(52) U.S. Cl. 705/1

(57) ABSTRACT

The invention is a method for unlocking value held by universities in the preemptive rights of their startup companies. In one embodiment, universities assign their preemptive rights to an investment fund. The investment funds monitors the companies for follow-on rounds of investment and analyzes the companies to determine for which rounds the fund should exercise preemptive rights. The fund provides the capital necessary to exercise the preemptive rights. A method of practicing the invention using a computer system is also provided. In another embodiment, a university establishes an affiliate organization owned and controlled by the university which has the rights to exercise the preemptive rights using capital provided by such a fund. In another embodiment, the fund provides the universities a portion of the manager's fees in exchange for preemptive rights.

### STATEMENT REGARDING FEDERALLY SPONSORED RESEARCH OR DEVELOPMENT

The present invention was not developed with the use of any Federal Funds, but was developed independently by the inventors.

### BACKGROUND OF THE INVENTION

In the course of fulfilling its/their primary education and research missions, university (including, but not limited to, degree granting educational institutions, non-profit research institutions, and teaching hospitals) faculty, students and staff make patentable observations/discoveries (intellectual assets) that have the potential to benefit society and advance the institution's goals. These intellectual assets include, but are not limited to, patentable inventions, copyright works, and ideas that form the basis of or may lead to new products and services. However, as academic conceptions, these ideas are not market ready, not mature products and often require further R&D in the private sector. To advance these embryonic ideas/discoveries to realize their potential and to satisfy market demands requires private sector expertise and human, financial and other resources beyond the mission, scope, capability or appropriate effort of academe. The process of moving academic discoveries from the laboratory to the marketplace (and bedside) is referred to as technology transfer and/or commercialization.

Therefore, to advance discoveries and to realize their potential, universities join (partner, license) with the private sector to attract and focus requisite expertise and resources to develop and commercialize. Most commonly, universities enter into intellectual property (patent) licenses with companies granting rights to patented/patentable discoveries for commercialization. These company licensees may be large companies with >500 employees, small companies with <500 employees or newly created companies/ventures (known as startups, spin outs or spin offs). The latter type, university startups are typically created by universities and their faculty, technology licensing offices and others specifically to commercialize discoveries or other opportunities based on IP rights.

Universities create and launch startups for a variety of reasons including, but not limited to, facilitate commercialization of a discovery through an entrepreneurial initiative, promote public benefit, promote commercialization of the discovery to advance commercial success, help retain and reward faculty and students interested in entrepreneurial activities, generate income and promote economic growth.

Creation of a startup to commercialize a discovery is most often appropriate if a discovery represents a scientific paradigm shift, revolutionary technology not yet accepted in the marketplace, a platform upon which more than one new product may be developed, in the absence of interest from established small and large companies. However, startups carry more risks than established companies including primarily managerial and financial risk.

Equity to the university is often a significant license consideration in startups. In effect, universities take equity in lieu of cash as up front consideration for the license. Universities may also take an extra allocation of equity as founders of the new venture. Equity may be in the form of stock, stock options and stock warrants. Equity is typically only one form of consideration in these licenses. Other considerations include up-front and periodic license fees, milestone payments, reimbursement of patent costs (historical and future/ongoing), annual maintenance fee payments, running and minimum royalties, and sponsored research funding. Financial returns from equity are independent of financial returns from other considerations, and equity may be realized even if the licensed IP fails to be commercially successful if the company is otherwise successful.

When universities create new startups and become equity holders, generally common stock, and they frequently receive/negotiate the right to invest along with other investors in future rounds of financing. This right to invest in future rounds is often referred to as preemptive rights. Preemptive rights provide the contractual right for an existing equity holder in a company to invest in the future financing rounds of that company. As these startups mature and show promise, investors of all sorts, including high quality venture capital firms, often invest in them. Universities have the ability to invest alongside these venture capital firms in the most promising university startups through their preemptive rights. Universities generally do not exercise these rights, however, as doing so requires access to capital, fast decision-making (usually within 30 days), and investment expertise.

It is possible to unlock the value in the unexercised preemptive rights of universities by partnering with universities to directly or indirectly finance the exercise of these Rights and to receive a portion of profit made on these equities in return for allowing the exercise the preemptive rights.

In addition to receiving shares of the startup company, the university will receive preemptive rights. Preemptive rights, also known as anti-dilution rights or come-along rights, gives the right to the university to participate in future rounds of funding in order to avoid dilution of its percentage interest in the company. Dilution occurs because most startup companies require multiple rounds of private equity funding. So if the university receives 10% of the company in the first round and then there is a second round the university's percentage interest in the company if it doesn't participate in that round will fall below 10% and typically may fall to 5% or lower depending on the valuation at the time of the second round. The preemptive rights give the university the right to participate in the second and later rounds at the same purchase price as the investors by contributing cash to the startup company. In addition to avoiding dilution, often times the second and later rounds involve preferred forms of stock which are more profitable than the common stock issued in the earlier round of funding. However, for the reasons stated earlier and others, universities rarely, in most instances, do not exercise their preemptive rights and these rights essentially go unused.

Another problem exists for the private equity community. Most startup ventures, whether funding technology from universities or private entrepreneurs, are high risk investments. Venture capitalists specialize in sorting through potential deals and finding the best deals to invest into to optimize their returns. However, as a practical matter, the best potential investments with the highest probability of success and the highest return often go to the venture capital funds with the best success record or the best name. Thus the venture capital funds that are historically in the top quarter of performance get access to the best deals leaving the remaining funds to sort through the remaining deals to try and find a few remaining jewels. The best venture capital funds often raise their capital from a select group of investors and are not open to new investors or charge very high premiums for investing. It is desirable for the average funds or new funds to be able to participate in and co-invest with the premium private equity funds but this is often very difficult to accomplish.

With respect to the universities, even if they do not exercise their preemptive rights, their holdings in various startup companies tend to be concentrated in the areas where their particular professors excel at research. Often times, this will be lopsided towards a few select areas. So, for example, a university with an excellent medical school and hospital may have a lot of biotech investments and fewer software, engineering or physical sciences based investments. As a practical matter universities may wish to diversify their holdings in these companies to improve their chance of participating in ventures that are successful.

It is also worthwhile to understand the way private equity funds are structured. Private equity funds, as referred to herein are also known as venture capital funds or investment funds and the term is not meant to be limiting to any particular structure, corporation or partnership, even though the typical structure is a limited partnership as will be described below. In the typical structure the fund is run by an experienced investor who acts as the general partner of the fund. The fund raises capital from institutional investors such as pension funds, university endowments, trusts, private family foundations and high net worth individuals. These investors become limited partners in the fund. In a typical arrangement, a fund may raise anywhere from ten million to several hundred million dollars. That fund will invest in a number of companies. Funds will sometimes be targeted towards certain technology areas or certain stage companies. Some funds are early stage funds, while others provide venture capital to more established companies. Funds will typically invest their capital along for a period of four or five years and then collect returns for the next five to ten years before the funds are liquidated. Often these funds are structured with the realization that many of the companies they invest in will not be successful but a few of them will be “home runs” and provide exceptional returns. Typically the fund manager/general partner receives a fee for managing the fund which is a percentage of the amounts invested. Also typically, the manager/general partner receives a percentage of the profit of the fund. In a typical arrangement, the limited partners out of the profits will first receive a 100% of their investment back and then any profits after that will be shared 20% by the general partner and 80% by the limited partners. This provides the general partner with tremendous incentive to find profitable deals. The share, in this example 20%, is often referred to in the industry as carry. The percentages in the above example are exemplary and many different structures are used. The invention is not meant to be limited to any particular structure or set percentages.

### BRIEF DESCRIPTION OF THE INVENTION

The invention is a method for unlocking value held by universities in the preemptive rights of their startup companies. In one embodiment, universities assign their preemptive rights to an investment fund. The investment funds monitors the companies for follow-on rounds of investment and analyzes the companies to determine for which rounds the fund should exercise preemptive rights. The fund provides the capital necessary to exercise the preemptive rights. A method of practicing the invention using a computer system is also provided. In another embodiment, a university establishes an affiliate organization owned and controlled by the university which has the rights to exercise the preemptive rights using capital provided by such a fund.

In another embodiment, the fund provides the universities a portion of the manager's fees in exchange for preemptive rights.

### BRIEF DESCRIPTION OF THE FIGURES

FIG. 1 shows the prior art with each university having an interest in various companies and the associated preemptive rights.

FIG. 2 shows the method of invention whereby universities contribute their preemptive rights to an investment fund.

FIG. 3 shows the resulting structure after the investment fund has exercised some of the preemptive rights.

FIG. 4 is a flow chart for practicing the method of the invention on a computer system.

FIG. 5 is a flow chart for a computer based accounting module for valuing participants' positions in the investment fund.

### DETAILED DESCRIPTION OF INVENTION

This invention consists of a method for providing capital to exercise universities' preemptive rights in startup companies that have been created as results of research at the universities. It also provides a method for the universities to diversify their portfolio of investments in such companies.

An investment fund is created by the manager of the fund and capital is raised for the fund. The capital may be in the form of cash actually provided to the fund or may be in “commitments” to provide capital at the time when the fund needs to invest in preemptive rights. The capital may be provided by the fund, the manager or outside investors. Universities may also choose to be investors in such a fund (either directly or through their endowment management affiliates). The fund then enters into contracts with one or more universities whereby each university assigns its rights to invest alongside of secondary rounds of funding i.e. preemptive rights to the fund. Preferably a participating university assigns all its rights so that the fund is protected from adverse selection; however this is not a requirement of the invention. The university may assign either just its rights going forward or may assign its rights for a number of years going back. Again certain investments that the university has previously made may be excluded from the contractual arrangement between the fund and the university.

In certain instances the preemptive rights may not be assignable in which case the fund would allow the university to invest through a corporate affiliate or some other corporate/contractual arrangement, the details of which may vary and are not critical to the invention. In one such arrangement, the university retains the preemptive rights (or assigns them to an affiliate), the fund provides capital to the university (or its affiliate) to exercise preemptive rights, and the fund receives the appropriate economic benefit if the startup is successful via contractual arrangements between the university (or its affiliate) and the fund. Such an embodiment is particularly useful where to preemptive rights are not assignable. Such an arrangement, or similar structures where there is not an actual assignment of rights to a fund are included within the term “transferring of preemptive rights.” Other arrangements, including trusts, partnerships, special purpose entities, preferred stock are also meant to be included within the term “transferring of preemptive rights” and within the scope of the invention. The key feature being that some of the economic benefits of the preemptive rights ultimately flow to the fund.

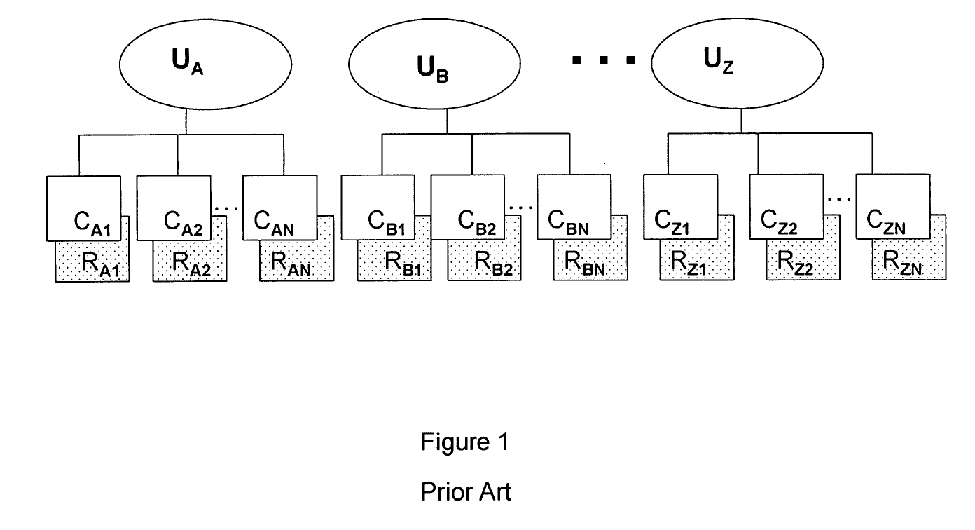

The prior art structure of universities, startup companies and preemptive rights is shown in FIG. 1. University A (designated U_{A}) has ownership interests in a plurality of companies (designated C_{A1} through C_{AN}), including preemptive rights in each of those companies (designated R_{A1} through R_{AN}). Note that universities don't always have preemptive rights in all their startup companies and this should not be considered a limitation of the invention. University B (designated U_{B}) has preemptive rights in a plurality of companies (designated C_{B1} through C_{BN}), including preemptive rights in each of those companies (designated R_{B1} through R_{BN}). This continues for a plurality of universities up through University Z (designated U_{B}) having preemptive rights in a plurality of companies (designated C_{Z1} through C_{BN}), including preemptive rights in each of those companies (designated R_{Z1} through R_{ZN}).

Note that in FIG. 1 each university's holdings are limited to its own startup companies. University A does not have the right to invest in a follow-on round for a University B company (such as C_{B2}).

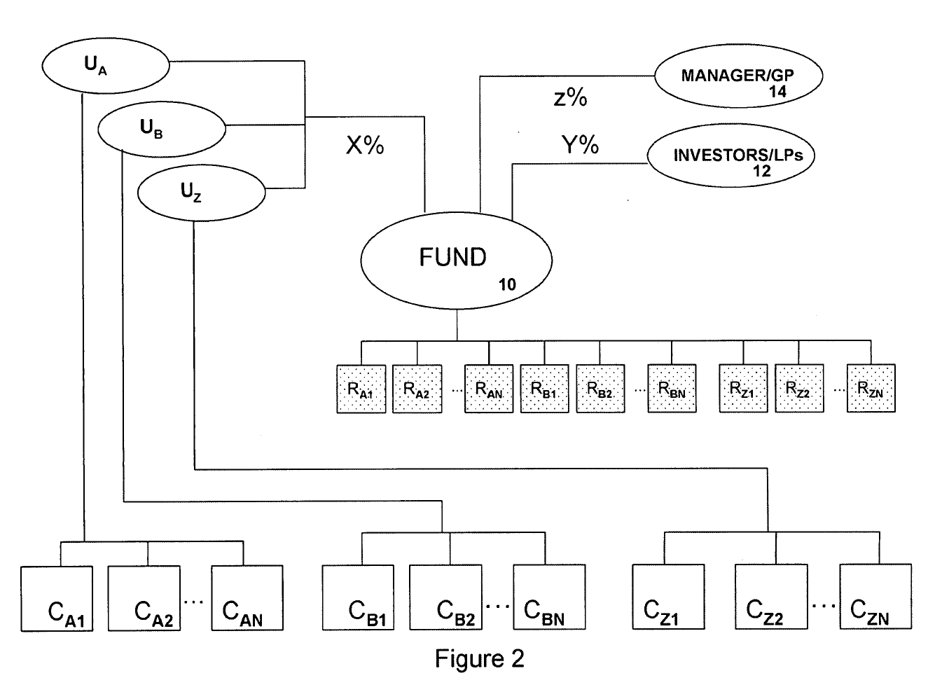

The result of the method of this invention is shown in FIG. 2. The preemptive rights R_{A1} . . . R_{ZN} that were previously owned by the universities U_{A} . . . U_{Z} are now assigned to the investment fund 10. The universities U_{A} . . . U_{Z} in exchange for contributing their preemptive rights R_{A1} . . . R_{ZN} to the fund 10 receive a percentage (X %) of the equity of the fund 10. Note that each university may receive a different percentage of equity of the fund 10 based upon the number or type of preemptive rights it contributes. Put another way, “X %” is not necessarily the same for each University. The universities U_{A} . . . U_{Z} may also receive fees from the fund 10 or the manager/general partner (not shown). The fund investors 12 also have an equity percentage (Y %) in the fund and as with the universities, not every investor necessarily has the same percentage of equity, since this will vary based on the amount of capital each investor contributed. Also, typically (but not necessarily) the fund manager/GP 14 retains a percentage of equity of the fund 10. Note that preferably each university still retains directly its ownership interests directly in the companies C_{A1} . . . C_{ZN} that it started with. In another embodiment of the invention (not shown) the universities U_{A} . . . U_{z} could contribute some or all of their equity interests in the companies C_{A1} . . . C_{ZN}.

One of the principal advantages of this invention, diversification, can now readily be seen in FIG. 2. Note that in addition to owning their original positions in each of their own startup companies, each university, through the fund 10 now owns preemptive rights in all of the other universities' startup companies. Theoretically a university diluted its own preemptive rights in order to achieve this diversification. However, since as a practical matter most universities rarely, if ever, exercise their preemptive rights, the diversification is achieved at no cost to the universities.

In one embodiment of the invention (not shown) the universities may retain the right but not the obligation to co-invest with the fund in the preemptive rights of its own startups. Typically this would be up to 50% of the value of the investment, but this is not necessarily the limit.

It should be noted that the X %, Y % and Z % shown may not be simple straight percentages. For instance, the investors/LPs 12 may have a right to receive their cash investment out of the fund profits before the remaining profits are divided up. Likewise the fund manager/GP 14 typically receives fees prior to profits being calculated (as may the universities). The particular method of dividing up profits, expenses and paying fees to the various fund participants may vary greatly and may be quite complicated. However, these arrangements are not intended to be a limitation of the invention.

In one embodiment of the invention the fund manager 14 receives a fee equal to 20% of the fund's profit. Each percentage point of profit is referred to in the investment industry as one point of carry. In one typical arrangement, the universities receive collectively five points of carry. One point of carry is allocated to universities that provide the fund with exclusivity with respect to their preemptive rights. Two points of carry is allocated by a first formula with each university's portion equaling the dollars invested by the fund in that university's companies divided by the total dollars invested by the fund in all companies. Another two points is allocated by a second formula with each university's portion equaling the fund's profit from that university's companies divided by the funds total profit from all companies. The foregoing embodiment is exemplary and not intended to limit the scope of the invention. It will be obvious to those skilled in the art that many other methods of allocating profits and interested to the universities are possible and all such variations are included within the scope of the invention.

With these rights in hand, the fund manager will monitor each of the startup companies to determine when there are follow-on rounds of investment. The assumption is that either the present investors or new investors will only put additional funding into each startup venture if it is a high quality investment. The investment fund can select which of the preemptive rights it wishes to exercise. The investment fund preferably will not be required to and ideally will not invest in all preemptive rights available. In one embodiment of the invention, one or more universities may require the fund to exercise preemptive rights in a certain number, percentage or type of startup. Alternatively, if the fund passes on the follow-on investment round, the preemptive rights may revert to the university that contributed them.

The key to the successful venture will be for the investment fund to determine which of the startup companies to exercise preemptive rights in when a follow-on round occurs. The investment fund may apply a number of screens to determine which rounds to participate in. In one embodiment of the invention the investment fund has its own analysts that do independent due diligence and make their own determinations. In another embodiment of the invention the investment fund uses certain financial criteria.

In another embodiment the investment fund uses certain industry segments such as deciding only to invest in software or biotech. In another embodiment the investment fund uses as a screen the venture funds that are funding the follow-on round. In this embodiment the investment fund may have a list of high quality venture funds (measured for example by historic returns or assets under management) that it wishes to co-invest with and if one of those venture funds is doing the follow-on round then the fund will exercise the preemptive rights. Obviously all of the above screens and methods can be used in combination as well as many other methods of determining which companies to invest in.

In the preferred embodiment universities will receive a percentage of the profits that the fund receives after the payout to the limited partners. For example, if the fund is receiving 20% of the profits the universities participating may receive 5% of the total profits (i.e. 25% of the fund manager's profit or carry). This can be done either by allowing the universities to receive the percentage of the profits of the preemptive rights they contribute, or of the profits of the preemptive rights of the entire fund, or some combination of one or more of these arrangements. Universities that may select to take the preemptive rights of the entire fund will have the advantage of broadening their portfolio and thus reducing their risks. On the other hand, certain universities who believe their startup companies are of a higher quality then those generally available at other universities may wish to only participate in their own preemptive rights (and not allow the other participating universities to share in those rights). The fund can be set up either way or as a mixture.

As additional incentive for universities to participate the general partner may also pay the universities fees during the life of the fund, prior to payout of profits. This payout would either come from the dollars in the fund but more likely would come from the fees that the general partner is paid from the fund.

It should also be noted that while “startup company” is used to describe the corporate entity that a university contributes or licenses its intellectual property to, the invention is not limited to true startups. In some instances it is not actually a startup company but may be an existing company that has acquired the rights, and even in these circumstances the university may have preemptive rights for follow-on rounds. Therefore the term startup company should be read broadly and not limited by the general term “startup.” A startup companies include any investment vehicle the university chooses to contribute or license intellectual property to that gives the university preemptive rights as part of the consideration. All such structures, including startup companies, are referred to herein as “companies.” Likewise, the term “follow-on” round is not meant to be limiting but includes any round of funding, including a round of initial outside funding (provided that the funds capital is provided directly or indirectly through the exercise of preemptive rights). Similarly, the term “preemptive rights” is not meant to be limited to rights related to follow-on investments to avoid dilution but also include any option, or warrant or similar right to purchase additional equity in a startup company.

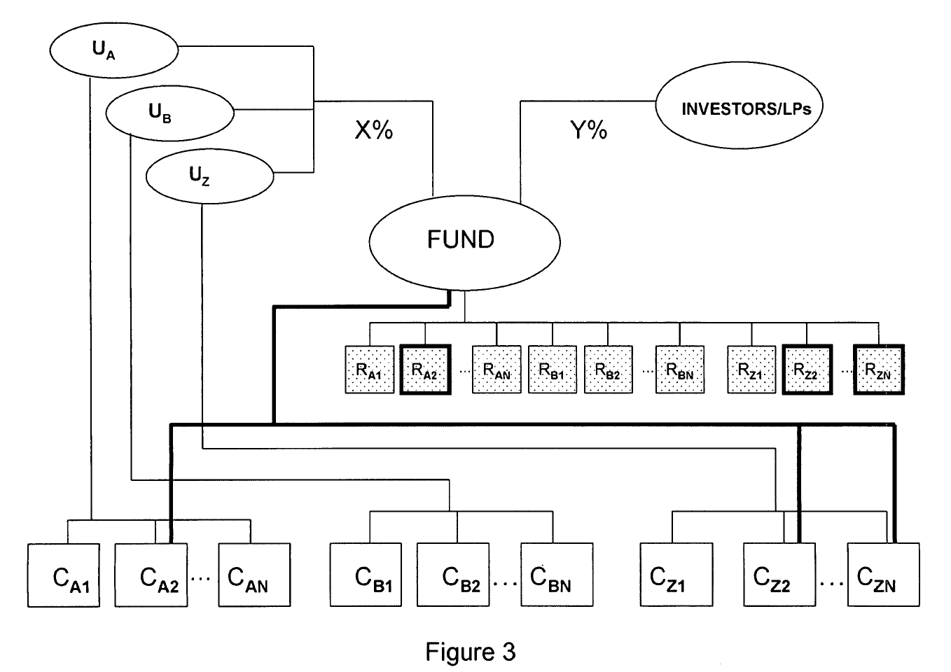

FIG. 3 shows a view of the fund structure after the fund 10 has exercised some of it preemptive rights R_{A1} . . . R_{ZN}. In this embodiment the fund 10 has exercised preemptive rights in companies C_{A2}, C_{Z2} and C_{ZN}. The fund 10 now owns equity positions in these three companies directly as indicted by the dark line in FIG. 3 connecting the fund 10 to these companies. The rights accompanying, R_{A2}, R_{Z2} and R_{ZN} these companies have also been highlighted in FIG. 3 for illustrative purposes. In most instances, but not necessarily in all, the fund still retains retain preemptive rights in C_{A2}, C_{Z2} and C_{ZN} so that the fund can choose to participate in future rounds of funding. Put another way, participating in a round of funding for a company does not exhaust the preemptive rights. On the other hand, in some cases, passing on opportunity to exercise preemptive rights in an early round of funding may preclude the fund 10 from participating in later rounds of funding.

Again, the diversification benefit to the universities U_{A} . . . U_{Z} of the present invention can readily be seen in FIG. 3. Note that either there were no follow on funding rounds for any of U_{B}'s companies C_{B1} . . . C_{BN}, or the fund 10 declined to exercise its rights. Notwithstanding this, U_{B}, through the fund 10, has equity positions in C_{A2}, C_{Z2} and C_{ZN}, which presumably are performing better than U_{B}'S companies. One could argue that U_{Z} has lost out because its companies are performing better, but it is hard to know this in advance, and in any event, that is the point of diversification. Even if one does think that U_{Z} lost out, as a practical matter it is irrelevant, since without the cash from the fund, U_{Z} almost surely would have failed to exercise its preemptive rights.

The equity percentage that a particular university receives will not necessarily be fixed. In the first place as additional universities or investors are added the percentage ownership of the existing universities will change. Further as universities form new startup companies going forward and contribute these their percentage interest in the fund may change as well. Also, in some embodiments of the invention, universities may opt to take only an interest related to the performance of their own companies. Likewise, in one embodiment of the invention, a university can hedge its bet by taking a partial interest in (say 50%) in just its own companies and a partial interest in the pool of companies. It will be obvious that there are many ways to structure each university's interests and the examples described herein are not meant to be limiting and the invention is intended to cover equity/payment structure.

A fund may also be structured with various pools based on the field of the companies. So a university contributing rights that are primarily bio-tech, may, instead of only taking a position in its own biotech companies, may want a position in all bio-tech investments in the fund. Alternatively, in order to diversify, since the university already has direct equity positions in many bio-tech companies (that is the companies it started), it may wish to take a position in the fund that is related to just software companies. There are many such variations available and the invention is meant to include all such variations within its scope. Also the invention is not limited to universities but can be applied to any entity that contribute capital, intellectual property or any other contribution of value to a startup company and receives preemptive rights in exchange. For example, a founding inventor may wish to exercise his preemptive rights that he received from a venture capital fund but not have funding to do that and the fund could choose to cooperate with the founding inventor to exercise his preemptive rights as well. Universities, because of their large pool of preemptive rights in many different startup companies are easier to work with then individual inventors.

The term “university” though should be read broadly to include any entity or individual that has preemptive rights that are exercisable in one or more startup companies. Other examples of such entities might be individuals (such as founders), hospitals, not-for-profit research institutes, for-profit research centers, government entities, and other investment funds or companies.

The term “interest” should likewise be read broadly given the many possible ways of providing payments to universities. An interest may be a full equity interest in the underlying companies, a profits interest in the fund or a portion of the fund, the right to receive guaranteed or fixed payments from the fund or fund manager, or a right to receive a portion of the fund manager's fees. Similarly, as described above the interest of a particular university may vary based on the exercise of preemptive rights in companies it contributed or the profit generated from companies it contributed. In some embodiments the fund manager receives a fee based on the assets of the fund/and or the assets invested by the fund. An interest provided to the university may include a portion of these types of fees as well (or any other payment received by the fund manager).

Returning to the concepts of using screens to determine which preemptive rights the fund should exercise, mathematical algorithms can be used to help determine which follow-on rounds to participate in. For example, if a follow-on round is funded exclusively by the same funders that participated in an earlier run that may be an indication that the investment is not as attractive as other investments. The theory being that the original investors or founders are unable to attract new investors and have to put their own money in order to protect their original investment. On the other hand, others could look at the same opportunity and see this as an indication of high value, the original investors not wishing to dilute their interest by allowing others to participate. Either way, a screen can be designed based on the comparison of the follow-on round of investors to the earlier round of investors. Another screen could be the value of the follow-on investment or the valuation of the company placed in the follow-on investment. So, for example, in an initial round of investment a company is valued at five million dollars and in the follow-on round the same company is valued at twenty-five million dollars, this is an indication that the startup venture is going well and is probably a good round in which to participate. Likewise, if the initial evaluation of the company for investment purposes was ten million dollars and the follow-on round valuation is only ten million dollars, this may be an indication that a low value can be placed on the company in order to attract another round of investments and therefore it is likely not as good of an opportunity to exercise the preemptive rights. Many will argue over the correct strategies here and the screens are probably not used best as a rule but more as a guideline to highlight which opportunities merit further due diligence.

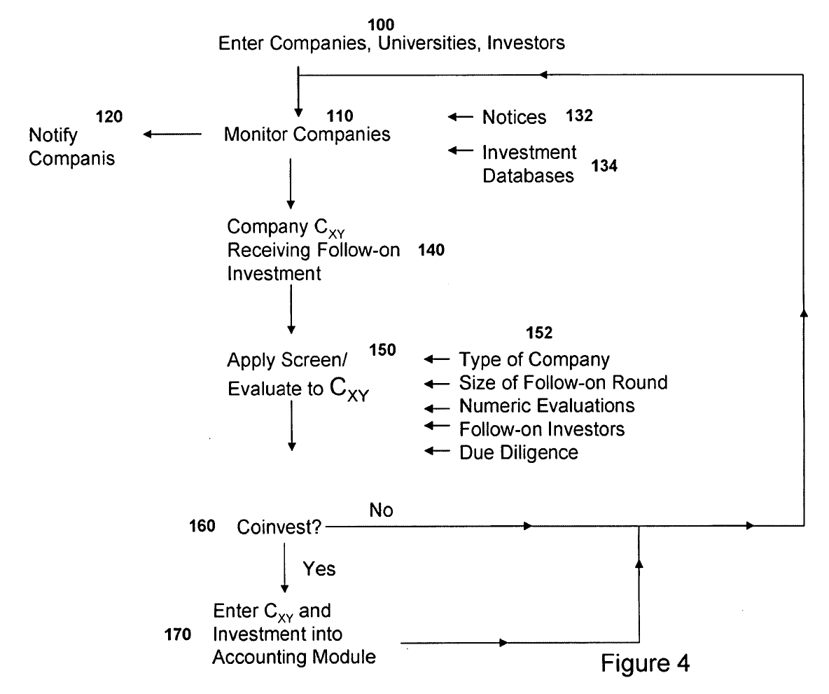

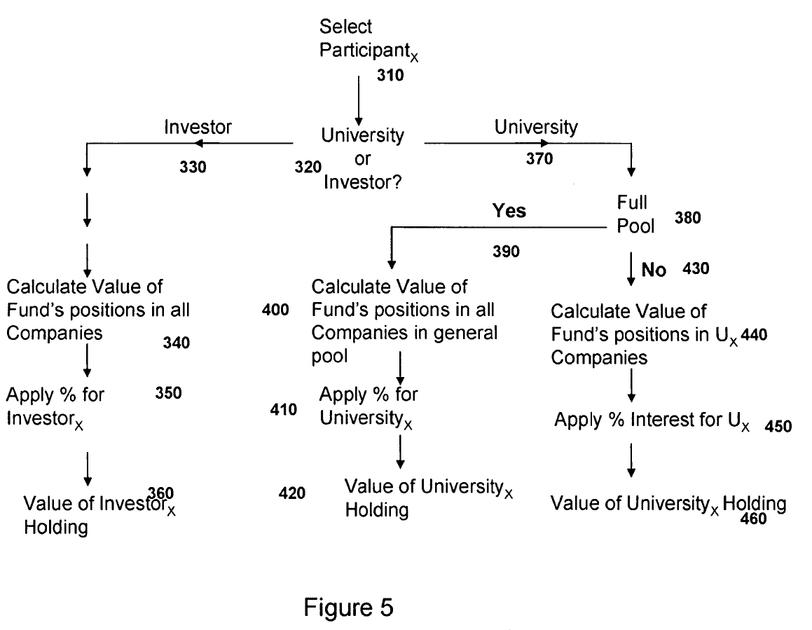

Monitoring these many investments and tracking the rights of the universities, the startup companies, the preemptive rights as well as valuations and limited partners is best done by computer. Therefore the invention includes a computer system for accepting and tracking the investment, identifying opportunities to exercise preemptive rights as shown in FIG. 4 as well as accounting module for valuing each of the investors/LPs or university stake holders share of the fund, as is shown in FIG. 5

The computer used to practice the method of this invention may be any type of computing device now known or hereinafter invented. It may consist of a single computer or a series of computers on a local or remote network. Generally the computer will have inputs for receiving data from human beings (ex: keyboard and mouse) as well as other computers (ex: internet access). The computer will generally also have outputs such as a monitor and a printer. The computer will usually also have a memory and well as a data storage system. The computer may be a personal computer, lap top, server, mainframe, handheld or any other type of computing device capable of receiving the necessary inputs, making the necessary calculations, and generating appropriate outputs.

The method of the invention is practiced as shown in FIG. 2. As each university joins the fund the university and its associated companies are entered into the computer 100, which the computer stores in a database. Additional data about each of the companies, such as the investors and controlling parties, addresses, nature of the business, university licensor, and current/historical valuation. In addition an equity stake in a fund is associated with a University. The computer then monitors all of the companies for which the fund has preemptive rights 110. The computer system will then generate a notice 120 to each company requesting to be notified by the Company in the event of any follow-on investment rounds. The notice generated by the computer may be and a letter, an email or an instruction to a human operator (perhaps an administrative assistant) to send a letter to the company. The notice may go to the company, its founders, and/or the lead investor of previous funding rounds.

The computer system continues to monitor 110 all the companies to see if there are any opportunities to exercise preemptive rights (a follow-on round of investment). Ideally, universities and companies will notify the fund when an investment opportunity occurs 132 and these notices will be input into the computer system. As a backup up to this procedure the computer can monitor various news feeds and private equity databases 134 that would discuss when companies are raising capital. This last step 134 would also be useful if a company failed to notify the fund and closed a round of investing. The fund could then contact the company and enforce its rights to participate in the investment round. The monitoring may also be done by human analysts who then input the information into the computer system.

Once a company C_{xy} has been identified as having a follow-on round of investment 140 the computer system then analyzes 150 the opportunity to determine whether or not to exercise the preemptive rights. The analysis may include many factors and metrics 152 as previously discussed in this disclosure. The various factors may be calculated by the computer and/or by human analysts with the results being input into the computer system. The computer system then makes a determination 160 as to whether the fund should exercise its preemptive rights and coinvest in the particular company C_{xy}. It outputs this determination on its monitor, printer or other output device. The fund manager will in all likelihood consider the computer systems determination as merely advisory and may override the computer's decision. In fact, the computer system instead of making a yes/no investment decision may output a score or set of scores that show how the company C_{xy} scores against the criteria on which it is measured. The computer system may also rank multiple companies against it other if several companies are being funded in the same time frame, or the computer system may rank the company C_{xy} against the existing pool of companies that the fund has already invested in.

If the fund decides to invest in the evaluated company C_{xy} the company's financial and investment information is entered 170 into the computer systems accounting module discussed below. The computer system then returns to monitoring 110 all the companies for follow-on investment rounds.

It is generally necessary for the manager/GP of an investment fund to provide quarterly reports on the value of investments to the investors/LPs of the fund. This provides particular challenges with this invention since these reports must also be generated for each of the universities. Typically, these reports will specify the % interest and value in the fund held by each of the LPs and universities. This calculation has complexity for several reasons. The interests of the universities versus the Investors/LPs will typically have to be calculated differently since the investors may have certain preferred rights. Secondly, even among the universities, some universities may choose to participate in the entire pool of companies while other universities may only wish to choose to participate in their own companies.

FIG. 5 shows a method used by a computer system to calculate the valuations needed for such reports. First a particular participant (Participant_{X}) is identified 310. A “participant” could either be a university or one of the investors/LPs. The fund manager may also be considered a participant, but is not shown here for simplicity. The computer then determines whether the Participant is an investor or a university 320. If the participant is an investor/LP (Investor_{X}) 330, then the computer system calculates 340 the value of the entire portfolio of companies held by the fund in which preemptive rights have been exercised. This calculation 340 may also consist of placing a value on the preemptive rights themselves, or the fund manager may decide to place no value on these since they are so speculative. Other factors and adjustments may also go into valuing the fund, such as debt or other obligations. Once the value of the fund is determined the percent interest of the Investor_{X} is applied to entire whole value 350 to obtain a value of Investor_{X}'s holdings 360. In many cases this will not actually be a simple percentage but a more complicated application of the nature of equity held, including preferred rights, payments to the fund manager and similar offsets. The variations are many and complex, but easily handled by a computer.

Alternatively, if the Participant_{X} is a university (University_{X}) the computer then determines if University_{X} is participating in the full pool of companies or just its own companies 380. If University_{X} is participating in the full pool of companies 390 then the calculation of the value of its share of the fund 400, 410, 420 is similar too that for an investor 340, 350, 360. There is one important difference at step 400. If some of the other universities have opted out of the general pool, then those universities companies would not be considered part of the general pool and not included in the value calculation at step 400.

If University_{X} is not participating in the full pool of companies 430 than the valuation needs to be performed based only on the companies for which University_{X} contributed preemptive rights 440. Then the percentage interest for University_{X} is applied 450 and the value of University_{X}'s position in the fund determined 460. Note that even though University_{X} did not choose do diversify its portfolio its percentage interest would not be 100% since the investors/LPs still must receive their share of value from University_{X} companies in exchange for providing the cash to exercise the preemptive rights. Likewise, the fund manager also receives an interest for providing management of the fund.

The steps shown in FIG. 5 can be repeated for each of the participants in the fund so that the value of each participant's holdings can be calculated. It should also be noted that the invention can be practiced as a single fund, a plurality of funds or a fund of funds. Further, the fund need not be structured as a limited partnership but may be any convenient entity or structure. Likewise, the fund need not have outside investors, but could invest its own capital. It should also be noted that while investors and LPs have been indentified as the same, the fund could be structured where the investors are shareholders or non-equity participants, the particular structure not being crucial to the invention. Likewise, universities could also be limited partners. It will be obvious to those knowledgeable about investment fund management and computers that the descriptions accompanying FIG. 4 and FIG. 5 are exemplary of techniques that can be used to implement the method of this invention on computers. Many other techniques are included within the scope of the invention and these examples are not indented to limit the scope of this invention.

We claim:

1. A method for exercising preemptive rights comprising:
transferring preemptive rights in companies held by one or more universities to an investment fund;
monitoring the companies for rounds of investment funding; and
exercising the preemptive rights in one or more of the companies.

2. The method of claim 1 wherein each university is provided with an interest in the fund in exchange for transferring the preemptive rights to the university.

3. The method of claim 2 wherein a portion of a university's interest is based upon the performance of all companies in the fund.

4. The method of claim 2 wherein a portion of a university's interest is based upon the performance of the companies for which said university transferred preemptive rights.

5. The method of claim 2 wherein a portion of a university's interest is based upon the value of investments made by the fund into companies for which said university transferred preemptive rights.

6. The method of claim 2 wherein a portion of a university's interest is based upon the performance of companies within a particular field.

7. The method of claim 2 wherein a university's interest is based upon some combination of equity interest in the fund and the performance of companies.

8. The method of claim 2 wherein the interest is a profits interest.

9. The method of claim 1 wherein the investment fund raises capital required to exercise the preemptive rights from one or more investors.

10. The method of claim 1 wherein a fund applies selection criteria to decide which companies to exercise preemptive rights in.

11. The method of claim 10 wherein the selection criteria include valuation of the fund at the time of a follow-on investment.

12. The method of claim 10 wherein the selection criteria include quality of the outside investors in a follow-on investment.

13. The method of claim 1 wherein each university receives one or more fee payments for from the fund or the fund's manager

14. The method of claim 1 wherein a university retains its preemptive rights and said university provides a portion of the economic benefit of said preemptive rights to the fund through contractual arrangements.

15. A computer based method for exercising preemptive rights comprising:
transferring to an investment fund the preemptive rights in companies held by one or more universities;
entering data in a computer system about the companies and preemptive rights;
the computer system analyzing each opportunity for exercising the preemptive rights; and
the computer system outputting a recommendation as to whether to exercise preemptive rights for a particular round of funding for one of the companies.

16. The method of claim 15 further comprising the step of the computer system calculating the value of one or more participants' interest in the fund.

17. The method of claim 15 wherein the interest is a profit's interest and the calculation involves a fixed portion and at least one portion determined by formula.

18. The method of claim 15 wherein the computer system monitors the companies to determine when an opportunity arises to exercise preemptive rights.

19. The method of claim 15 wherein the step of analyzing includes valuation of the fund at the time of a follow-on investment.

20. The method of claim 15 wherein the step of analyzing includes valuation of the fund at the time of a follow-on investment.
